(19) United States
(12) Patent Application Publication
(10) Pub. No.: US 2025/0319937 A1
(43) Pub. Date: Oct. 16, 2025

(54) Bottom Bracket Cover and Associated Bicycles and Methods

(71) Applicant: Triunfo Sports LLC, Westlake Village, CA (US)

(72) Inventors: Jacob Rheuban, Westlake Village, CA (US); James Huth, Newbury Park, CA (US)

(73) Assignee: Triunfo Sports LLC, Westlake Village, CA (US)

(21) Appl. No.: 18/637,301

(22) Filed: Apr. 16, 2024

(51) Int. Cl. B62H 7/00; B62J 25/00; B62K 3/02

(52) U.S. Cl. CPC B62H 7/00; B62J 25/00; B62K 3/02

(57) ABSTRACT

A cover for a bottom bracket of a bicycle, including a rounded body having an inner side, an outer side opposite the inner side, and a central aperture. The inner side has a surface configured to contact an outer surface of a bottom bracket shell of the bicycle and the central aperture extends through the body from the inner side to the outer side. The cover further includes a first fastener and an engaging element. The first fastener extends through the central aperture, and the engaging element is configured to prevent rotation of the rounded body by engaging the bottom bracket shell of the bicycle.

### BACKGROUND OF THE INVENTION

A modern approach to teaching a child to ride a bike involves starting with a balance bike, which is often simply a bicycle with no pedals. The child first learns the key skill of balance on the balance bike, then switches to a pedal bike to learn the remaining aspects of riding a bike.

While the approach is effective and popular, a balance bike is required. Guardians may (a) purchase a separate balance bike, (b) purchase a convertible bike, or (c) converting a standard child's bike, each of which has drawbacks. Purchasing a separate bike is expensive, and requires the child to adjust to the balance of a new bike while simultaneously learning to pedal. Currently available convertible bicycles compromise the weight, performance, and strength of the bike, particularly in the pedal bike configuration.

Converting a standard bike can be complicated, and require specialized tools. If only the pedals of a standard bicycle are removed, the crank and chain are still on the bike, which makes the bike heavy and cumbersome to learn on, since the rider's legs may rub against the crank and chain. Removing the crank exposes the bottom bracket spindle, so the bottom bracket may also require removal to provide safe clearance for the rider.

Fully removing the drive train on a bike may therefore require a crank puller, a chain tool, and a bottom bracket tool. These tools are not only uncommon, but somewhat technical to use. Few bicycle owners have access these tools, or would feel comfortable using the tools to convert a bicycle.

Therefore, a bicycle than can be easily converted between a balance bike and a pedal bike without compromise in the weight, strength and performance is desirable.

### SUMMARY OF THE INVENTION

The present disclosure provides systems, apparatus, and methods relating to convertible bicycles and conversion of pedal bikes to balance bikes. In some examples, a cover for a bottom bracket of a bicycle may include a rounded body having an inner side, an outer side opposite the inner side, and a central aperture. The inner side may have a surface configured to contact an outer surface of a bottom bracket shell of the bicycle and the central aperture may extend through the body from the inner side to the outer side. The cover may further include a first fastener and an engaging element. The first fastener may extend through the central aperture, and the engaging element may be configured to prevent rotation of the rounded body by engaging the bottom bracket shell of the bicycle.

In some examples, a balance bicycle may include a frame having a bottom bracket shell, a bottom bracket in the bottom bracket shell, and first and second covers. The first cover may be over a first end of the bottom bracket, and a second cover may be over a second end of the bottom bracket. Each cover may be fastened to the bottom bracket.

In some examples, a foot rest of a bicycle may include a body having a flat upper surface and a lower tab. The foot rest may further include a crank bolt and a threaded faster. The crank bolt may extend through the body to engage a spindle of a bottom bracket of the bicycle, and the threaded fastener may extend through an aperture of the tab. The foot rest may cover one end of the bottom bracket and be mounted to the bicycle in a fixed orientation.

Features, functions, and advantages may be achieved independently in various examples of the present disclosure, or may be combined in yet other examples, further details of which can be seen with reference to the following description and drawings.

### BRIEF DESCRIPTION OF DRAWINGS

FIG. 1 is a side elevation view of an illustrative convertible bicycle in accordance with aspects of the present disclosure, in a pedal bike configuration.

FIG. 2 is a side elevation view of the convertible bicycle of FIG. 1, in a balance bike configuration.

FIG. 3 is an isometric detail view of a bottom portion of the convertible bicycle of FIG. 2, including illustrative bottom bracket covers in accordance with aspects of the present disclosure.

FIG. 4 is an exploded isometric detail view of the bottom portion of the convertible bicycle of FIG. 2, from below.

FIG. 5 is a cut-away view of the bottom portion of the convertible bicycle of FIG. 2, cut along line 5-5 in FIG. 3.

FIG. 6 is an exploded isometric view of the bottom bracket, bottom bracket shell, and one bottom bracket cover of the convertible bicycle of FIG. 2.

FIG. 7 is an exploded isometric view of a rear dropout of the convertible bicycle of FIG. 2.

FIG. 8 is a cross-sectional view of another pair of illustrative bottom bracket covers, mounted on a bottom bracket and a bottom bracket shell of a bicycle.

FIG. 9 is a flow chart depicting steps of an illustrative method for converting a convertible bicycle, according to the present teachings.

FIG. 10 is a flow chart depicting steps of an illustrative method for converting a standard bicycle to a balance bicycle, according to the present teachings.

### DETAILED DESCRIPTION OF THE INVENTION

Various aspects and examples of a bottom bracket cover, as well as convertible bicycles including bottom bracket covers, and related methods of converting a bicycle, are described below and illustrated in the associated drawings. Unless otherwise specified, a cover, bicycle, or method in accordance with the present teachings, and/or its various components may, but are not required to, contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed examples. The following description of various examples is merely illustrative in nature and is in no way intended to limit the disclosure, its application, or uses. Additionally, the advantages provided by the examples described below are illustrative in nature and not all examples provide the same advantages or the same degree of advantages.

This Detailed Description includes the following sections, which follow immediately below: (1) Definitions; (2) Overview; (3) Examples, Components, and Alternatives; (4) Illustrative Combinations and Additional Examples; (5) Advantages, Features, and Benefits; and (6) Conclusion. The Examples, Components, and Alternatives section is further divided into subsections A through C, each of which is labeled accordingly.

### Definitions

The following definitions apply herein, unless otherwise indicated.

“Substantially” means to be predominantly conforming to the particular dimension, range, shape, concept, or other aspect modified by the term, such that a feature or component need not conform exactly, so long as it is suitable for its intended purpose or function. For example, a “substantially cylindrical” object means that the object resembles a cylinder, but may have one or more deviations from a true cylinder.

“Approximately” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of the specified value, insofar as such variations are appropriate to perform in the disclosure. It is to be understood that the value to which the modifier “approximately” refers is itself also specifically, and preferably, disclosed.

The terms “bicycle” and “bike” may are used interchangeably herein, and should be understood as equivalent. A “standard” bicycle or bike as used herein means any commercially available pedal-driven bicycle not designed, configured, or intended for conversion to a balance bicycle.

### Overview

In general, a convertible bicycle in accordance with the present teachings may include a crankset and frame assembly configured to allow removal of the crank arms and chain with common tools, and a pair of bottom bracket covers. Each of the pair of bottom bracket covers may be as described below.

A bicycle crankset or chainset may include one or more chainrings or sprockets, and a pair of cranks or crank arms. Each crank arm may have one of the pedals of the bicycle at a distal end, and attach to a bottom bracket at the proximal end. The chainrings may also attach to the proximal end of one of the two crank arms.

A bicycle's bottom bracket may allow the crankset to rotate freely. The bottom bracket may include a spindle to which the crankset attaches, and the bearings that allow the spindle and crankset to rotate. Bottom bracket bearings fit inside the bottom bracket shell, which connects the seat tube, down tube and chain stays as part of the bicycle frame.

How the crank arms connect to the bottom bracket may depend on the type of crankset. Most commonly, cranksets may be either a 2-piece or 3-piece type. In 2-piece cranksets, one crank arm includes a built-in axle or spindle. The built-in spindle of that crank arm extends through the bottom bracket to connect to the other crank arm.

In 3-piece cranksets, the bottom bracket includes a spindle and each crank arm is fastened to the bottom bracket spindle by a crank bolt. Bottom bracket spindle shapes vary, but common spindle types may include a square tapered spindle, a hexagonal tapered spindle, and a splined spindle. The square tapered spindle may have approximately a 2 degree taper with respect to a center line, and a diamond or square cross-sectional shape with four flat faces and rounded corners.

A majority of crank arms may require a specialized tool called a crank puller to remove from the bottom bracket. Some cranksets may be designed for use with a self-extracting crank bolt, such as the one described in U.S. Pat. No. 5,791,203, which is hereby incorporated by reference in its entirety. As explained in the patent, a tapered hole in the crank arm is threaded to engage with the outer threads of the bolt cover. The bolt cover is provided with an axial hole through which a rotating device such as a hexagonal wrench may be passed, and which has a hexagonal cross-sectional configuration. The head of the bolt is provided with a hexagonal hole of smaller diameter than the axial hole of the cover. The bolt can be fastened or unfastened by engaging a hexagonal wrench with the head of the bolt through the axial hole of the bolt cover. As the bolt is unfastened, the head of the bolt is caused to move outwards so as to force the tapered hole of the crank arm to disengage from the receiving portion of the crank axle (bottom bracket).

A convertible bicycle as described herein may include a standard and/or commercially available bottom bracket, and may be configured to allow an owner or rider to remove the crankset from the bottom bracket using only commonly available tools such as hex wrenches or Phillips screwdrivers. The bicycle may include at least one self-extracting crank bolt, and a compatible crankset. Such a bicycle may alternatively or additionally include any mechanism or fastener of equivalent functionality.

A majority of bike chains may require a chain tool or specialized pliers to remove or open a link, in order to take the chain off the bicycle. Otherwise the chain would remain trapped by the frame of the bicycle. A convertible bicycle as described herein may be configured to allow removal of the chain without opening the chain or any link of the chain.

In some examples, the bicycle may include at least one split frame element or disconnectable frame assembly which allows disconnection of at least one end of a chain or seat stay. For example, one of the rear dropouts may be part of an assembly including first and second separate portions, which can be fastened together or unfastened as needed.

In some examples, the bicycle may include an elevated chainstay. In many bicycle frames, both chainstays connect to the seat tube and down tube indirectly through the bottom bracket shell. An elevated chainstay may be on the same side of the bicycle as the chain, and may be elevated above the chain. Specifically, the chainstay may connect to the seat tube above the chain drive of the bicycle. As a result, the chain may not be trapped by the fixed triangle of the seat stay, chain stay, and seat tube, and can be removed without disconnection of any links.

As noted above, a convertible bicycle may include a pair of bottom bracket covers. Bottom bracket covers may additionally or alternatively be configured for use in conversion of a standard bicycle to a balance bicycle. In general, a bottom bracket cover in accordance with the present teachings may be configured to attach to one end of a bicycle's bottom bracket, and cover that end of the bottom bracket. The main body of the cover may render the bottom bracket safe from dust, debris, and a rider of the bicycle, and in turn protect the rider from knocking into a spindle or other projections of the bottom bracket.

A bottom bracket cover may include a main body with a central aperture. The cover may be configured for a specific bottom bracket and/or bottom bracket specification. For example, size, shape, and/or extent of the central aperture may depend on the bottom bracket. A cover for a 2-piece crankset compatible bottom bracket may differ from a cover for a 3-piece crankset compatible bottom bracket.

A cover for a 2-piece crankset compatible bottom bracket may include and/or be configured to attach to a replacement spindle. For example, one of a pair of covers may include an elongate central element matching dimensions of the crankset spindle or axle, and the other of the pair of covers may attach to a distal end of that central element. For another example, each cover may be configured to fasten to a separate elongate member matching dimensions of the crankset spindle or axle, and/or may include other attachment features such as threading of the central aperture of the cover to facilitate attachment to the separate elongate member.

A cover for a 3-piece crankset compatible bottom bracket or integrated spindle bottom bracket such as a square taper bottom bracket may be configured to attach to the spindle of the bottom bracket. For example, the central aperture of the cover may extend through the cover from an inner side to an outer side, allowing a fastener to be inserted from the outer side of the cover to engage the spindle. The cover may be fastened to the spindle of the bottom bracket by a fastener of the crankset such as a crank bolt or square taper spindle nut, or may include a dedicated fastener for the cover.

A bottom bracket cover may further include features such as anti-rotation and/or foot rest structures. For example, the cover may include a flat upper surface for a rider to rest a foot on while riding. For another example, the cover may include an engaging element which prevents rotation of the cover by engaging the frame of the bicycle in some manner. For instance, a tab may extend from the cover over a bottom bracket shell of the frame and a fastener may extend through the tab to frictionally engage the bottom bracket shell or threadedly engage a hole in the bottom bracket shell. For instance, the cover may include a circumferential flange at an inner side to overlap the bottom bracket shell and a high-friction material to contact and grip the surface of the bottom bracket shell.

A bottom bracket cover may be manufactured according to any effective method, of any sufficiently strong material. The cover may be unitary, or may include an assembly of multiple materials. For example, the cover may be injection molded or thermoformed from a rigid plastic such as polyvinyl chloride or polypropylene. For another example, the cover may include padding or shock absorbing materials, and/or may include materials appropriate to bicycle frame construction such as aluminum. Preferably, the cover may be lightweight and robust.

### Examples, Components, and Alternatives

The following sections describe selected aspects of exemplary bottom bracket covers and convertible bicycles as well as related systems and/or methods. The examples in these sections are intended for illustration and should not be interpreted as limiting the entire scope of the present disclosure. Each section may include one or more distinct examples, and/or contextual or related information, function, and/or structure.

### A. Illustrative Convertible Bicycle

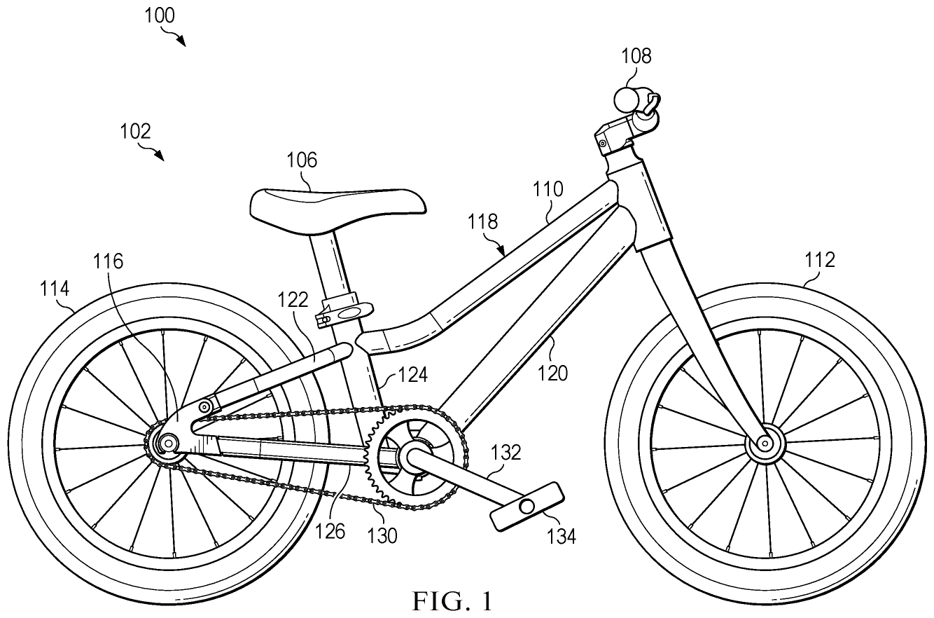

As shown in FIGS. 1-7, this section describes an illustrative bicycle 100. Bicycle 100 is an example of a convertible bicycle, as described above.

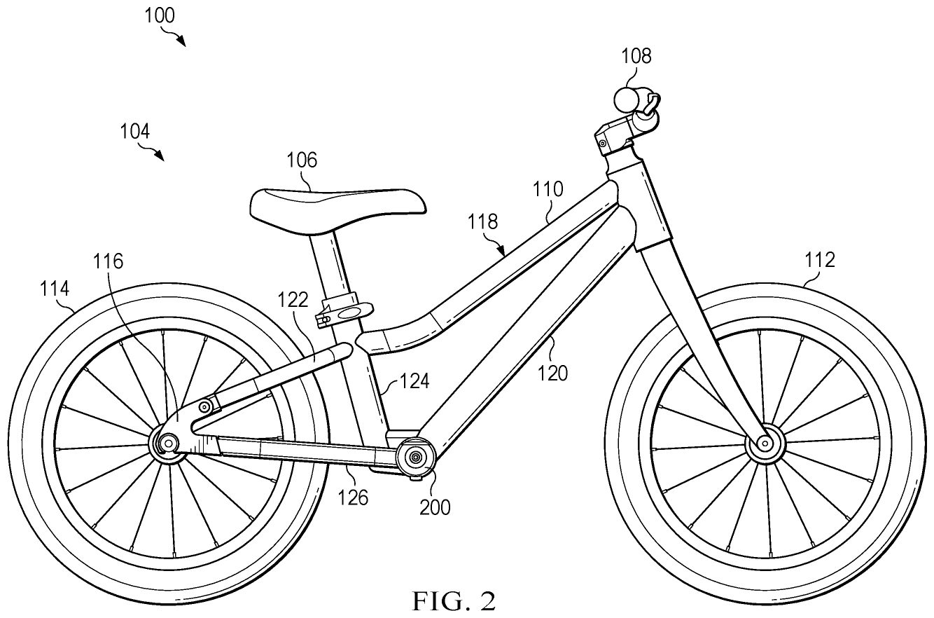

FIG. 1 depicts bicycle 100 in a pedal bike configuration 102, while FIG. 2 depicts the bicycle in a balance bike configuration 104. Bicycle 100 may be described as convertible between a pedal bike and a balance bike. The bicycle may be converted by an owner or rider according to a method such as method 500, described below.

Bicycle 100 may be convertible with only widely used and commonly available tools such as a screwdriver. In the depicted example, the bicycle is convertible using only three sizes of Alan key or hex wrench. The relevant bolts may be sized such that a standard set or combination tool may include all three needed sizes of hex wrench.

In both pedal bike configuration 102 and balance bike configuration 104, bicycle 100 includes a seat 106, handlebars 108, a frame 110, a front wheel 112, and a rear wheel 114. The bicycle may include any appropriate design, material, or technology for each of the seat, handlebars, frame, and wheels. For example, the bicycle may include drop or flat handlebars; tubular, clincher, or tubeless wheels; and/or quick-release or thru axles.

While balance bikes may be commonly used for children learning to ride, a convertible bicycle may also be advantageous for learners at any age. Accordingly, bicycle 100 may be sized for a child, teen, or adult rider. The bicycle may further include any desirable features or accessories. For example, bicycle 100 may include hand brakes, a kickstand, gearing, shocks, and/or a chain guard.

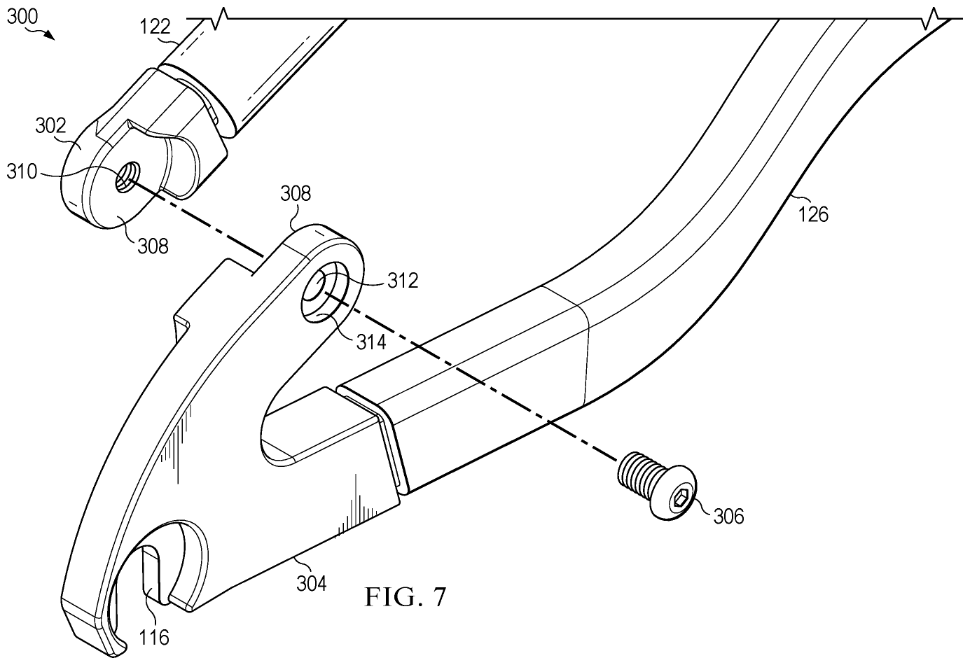

Frame 110 may be described as functionally equivalent to a non-convertible bicycle frame. That is, frame 110 may offer substantially the same weight, strength and performance of a similarly designed frame on a non-convertible bicycle. In some examples, frame 110 may be identical to a pedal bike frame apart from one of rear dropouts 116, as described further below with reference to FIG. 7.

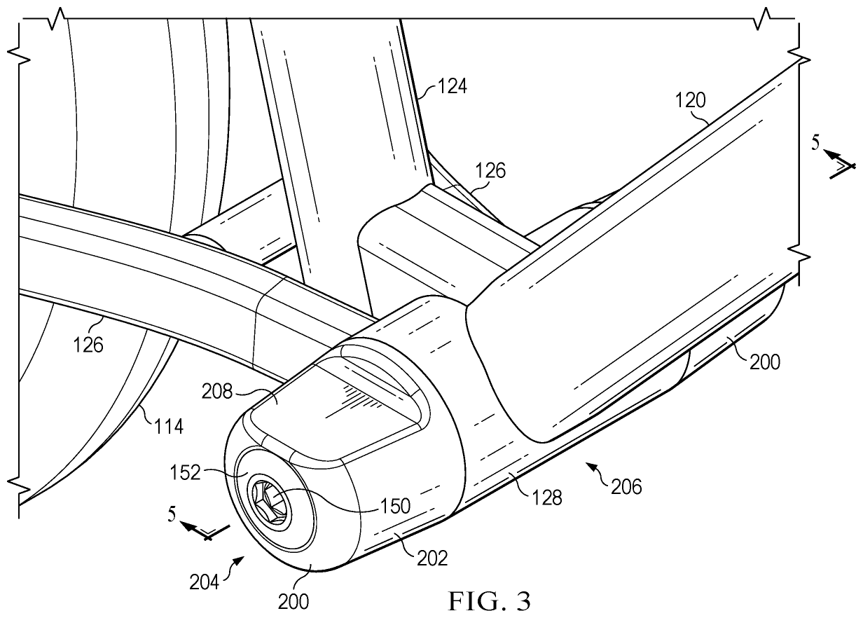

In the depicted example, frame 110 is a diamond or step-over frame. Specifically, frame 110 includes a top tube 118 and a down tube 120. A pair of seat stays 122 extend between rear dropouts 116 and a seat tube 124. Similarly, a pair of chain stays 126 extend between the rear dropouts and a bottom bracket shell 128, which can be seen in FIG. 3. Down tube 120 also attaches to bottom bracket shell 128.

As shown in FIG. 1, in pedal bike configuration 102, bicycle 100 has a chain drive including a crankset and a chain 130. The crankset includes a chainring, a pair of crank arms 132, and pedals 134. In pedal bike configuration 102, bicycle 100 may be propelled by pedaling and ridden according to standard riding practice. In pedal bike configuration 102, bicycle 100 may be described as a pedal bicycle. The bicycle may be operationally equivalent to a standard bicycle of similar design.

In the depicted example, bicycle 100 is single gear. In some examples, the chain drive of bicycle 100 may include additional or alternative elements such as chainrings and/or derailleurs.

As shown in FIG. 2, in balance bike configuration 104, bicycle 100 does not include the chain, chainring, crank arms, or pedals of the chain drive. Instead, the bicycle includes a pair of bottom bracket covers 200. In balance bike configuration 104, bicycle 100 may be propelled by kicking off from the ground, pushing by a non-rider, a slope, and/or any such means. A rider may rest one or both feet on bottom bracket covers 200. In balance bike configuration 104, bicycle 100 may be described as a balance bicycle.

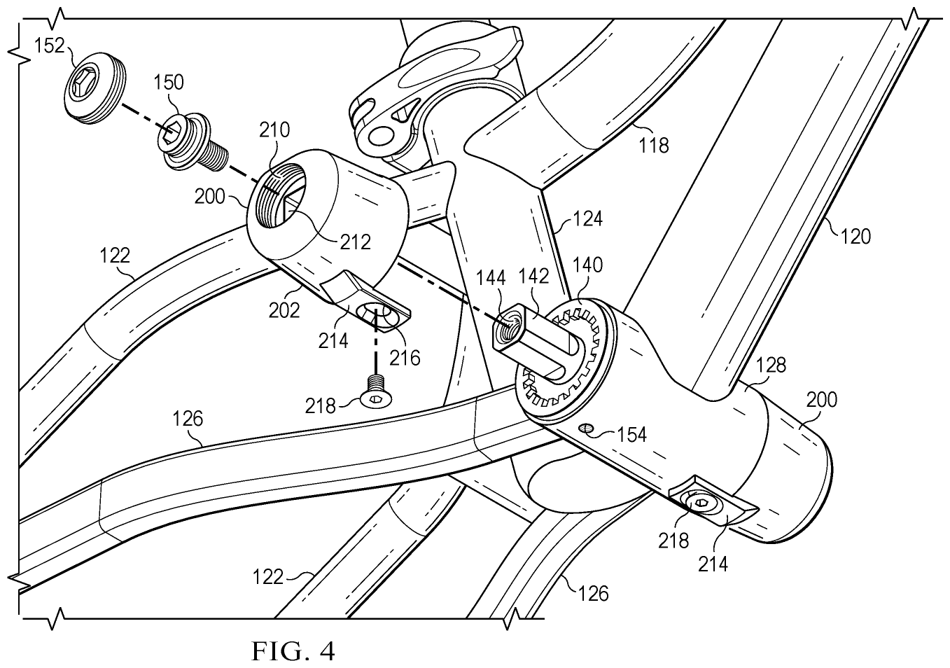

FIG. 3 is a detail view of a bottom portion of bicycle 100 in balance bike configuration 104, showing bottom bracket shell 128 of frame 110. The bottom bracket shell connects down tube 120 to seat tube 124 and chain stays 126, and houses a bottom bracket 140, which can be seen in FIG. 4. In FIG. 3, the bottom bracket is obscured by covers 200.

In the present example, covers 200 are substantially identical. The following description may be understood to apply equally to both covers. In some examples, the pair of covers may include a right-side cover and a left-side cover with differing features, as described in Example B, below.

Cover 200 has a rounded body 202. In the depicted example, body 202 has a substantially cylindrical shape with a domed or rounded outer side 204 and a circular, flat inner side 206. Body 202 may also be described as slightly tapered and/or frusticonical.

Body 202 may have any appropriate shape, but may preferably be rounded to improve rider safety. That is, body 202 may be shaped to avoid sharp corners, edges, or rough textures that might catch or injure a rider's leg. In the present example, body 202 is additively manufactured from a rigid plastic. Cover 200 may include any material or materials appropriate to rider safety.

In the depicted example, inner side 206 of each cover 200 is flush with bottom bracket shell 128. That is, the inner side has a circumference matching the bottom bracket shell and contacts the bottom bracket shell such that no substantial gap is present between the cover and the bottom bracket shell. The bottom bracket is entirely enclosed by covers 200 and bottom bracket shell 128.

In some examples, cover 200 may fit over bottom bracket shell 128 such that an inner circumferential surface of the cover contacts an outer circumferential surface, as described further in Example B, below. In some examples, inner side 206 may be spaced from the bottom bracket shell. Preferably, the cover may interface with the bottom bracket shell such that a rider's clothing does not catch in any gap or opening, and dust and debris do not reach the enclosed bottom bracket.

Cover 200 may be used as a foot rest, and may also be referred to as a foot rest. The cover includes a flat upper surface 208. Cover 200 may also be described as having a recess or cut-out on top. In the depicted example, upper surface 208 extends from outer side 204 toward inner side 206, but does not extend the full length of the cover. In general, upper surface 208 may have any shape, extent, and/or other characteristics appropriate to a foot rest. That is, upper surface may be configured to provide a convenient and/or comfortable surface for a rider to rest a foot on while coasting.

Upper surface 208 may be substantially flat, but may also include contoured and/or textured areas. For example, the upper surface may include a plurality of domed protrusions to provide improved grip. For another example, the upper surface may have a covering of high-friction material.

Cover 200 is fastened to the bottom bracket by a self-extracting crank bolt 150. Crank bolt 150 may be the fastener used to attach one of crank arms 132 (see FIG. 1) to the bottom bracket in the pedal bike configuration of the bicycle. In the depicted example, crank bolt 150 includes a threaded cap 152, and is a self-extracting crank bolt as described above.

Crank bolt cap 152 and crank bolt 150 are each configured for use with a hex wrench. The cap may be for use with a larger wrench, allowing access to the covered bolt. A user converting from pedal to balance bike configurations may use the smaller size hex wrench to both unscrew crank bolt 150 and remove the crank arm. The user may use the larger size hex wrench to unscrew cap 152 from the crank arm and remove both the cap and crank bolt. The crank bolt 150 and cap 152 may then be used to fasten cover 200 to the bottom bracket, in place of the crank arm.

In FIG. 4, one of covers 200 is depicted as exploded to show bottom bracket 140, the cover, crank bolt 150, and cap 152. The other cover is shown mounted to the bottom bracket. As shown, bottom bracket 140 is a square taper bracket and includes a spindle 142 with a central threaded aperture 144.

Spindle 142 may rotate freely relative to the rest of bottom bracket 140, and may also be described as an axle or crank axle. Cover 200 is attached to bottom bracket 140 by a fastener engaging threaded aperture 144 of spindle 142. That is, the cover is fastened to the spindle of the bottom bracket.

In the present example, the fastener engaging the spindle is crank bolt 150. In some examples, cover 200 may include a dedicated fastener configured to engage spindle 142. For example, cover may include a separate Phillips-head bolt with a diameter and thread size matching aperture 144 of the spindle. For another example, the cover may include an integral elongate threaded portion with a diameter and thread size matching aperture 144. In such an example, a user may manually screw the cover onto the spindle by grasping body 202.

Cover 200 is configured to receive the head of crank bolt 150 and cap 152, such that the cap is flush with the domed outer side of body 202 of the cover. The body includes a recess 210 in the outer side that is sized and shaped to accommodate both the head of crank bolt 150 and cap 152. Recess 210 is in communication with a central aperture 212 of body 202. Recess 210 may also be described as forming an outermost section of central aperture 212.

In the present example, recess 210 is threaded to engage and retain cap 152 in place. In some examples, an inner surface of recess 210 may be un-threaded or smooth. Recess 210 may conform to a specific crank bolt or fastener, as in the present example. Alternatively or additionally, the recess may be sized and/or shaped to accommodate a variety of fasteners, in order that cover 200 may be used for a variety of convertible and/or standard bicycles.

Since spindle 142 is designed to rotate in bottom bracket 140, cover 200 may also rotate unless restrained in some manner. In the depicted example, body 202 includes a tab 214 to allow cover 200 to be fixed to the frame of the bicycle as well as to the bottom bracket. The tab extends from a lower side of the body, opposite the flat upper surface, and toward bottom bracket shell 128. When mounted to the bottom bracket, tab 214 overlaps the bottom bracket shell. Tab 214 may be described as extending from a bottom edge of the inner side of the body and/or as extending parallel central aperture 212. Tab 214 may also be described as contacting an outer circumferential surface of bottom bracket shell 128.

Tab 214 includes an elongate aperture, or slot 216. The slot lines aligns with a threaded hole 154 in bottom bracket shell 128, and a threaded fastener or bolt 218 extends through the slot to engage the hole. Cover 200 may be thereby fastened in a fixed orientation relative to the frame, and prevented from rotating. Slot 216 may be elongate parallel the extent of tab 214 and/or a direction of installation of the cover. The slot may thereby provide tolerance in alignment with hole 154 of the bottom bracket shell.

In some examples, cover 200 may additionally or alternatively include other engaging elements to prevent to rotation. The engaging elements may be configured to engage specifically designed features of a convertible bicycle frame, and/or to engage a standard bicycle frame For example, bolt 218 may be tightened against the outer circumferential surface of bottom bracket shell 128 to frictionally engage the frame.

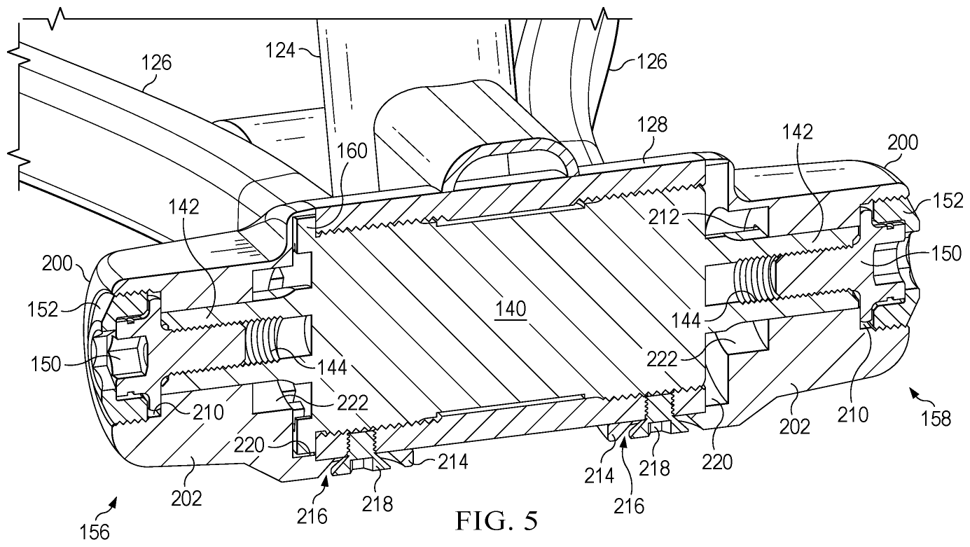

FIG. 5 is a cut-away view of the bottom portion of bicycle 100 shown in FIGS. 3-4, cut along line 5-5. As shown, bottom bracket 140 is fully enclosed by covers 200 and bottom bracket shell 128. Interior details of the bottom bracket such as bearings are omitted for simplicity.

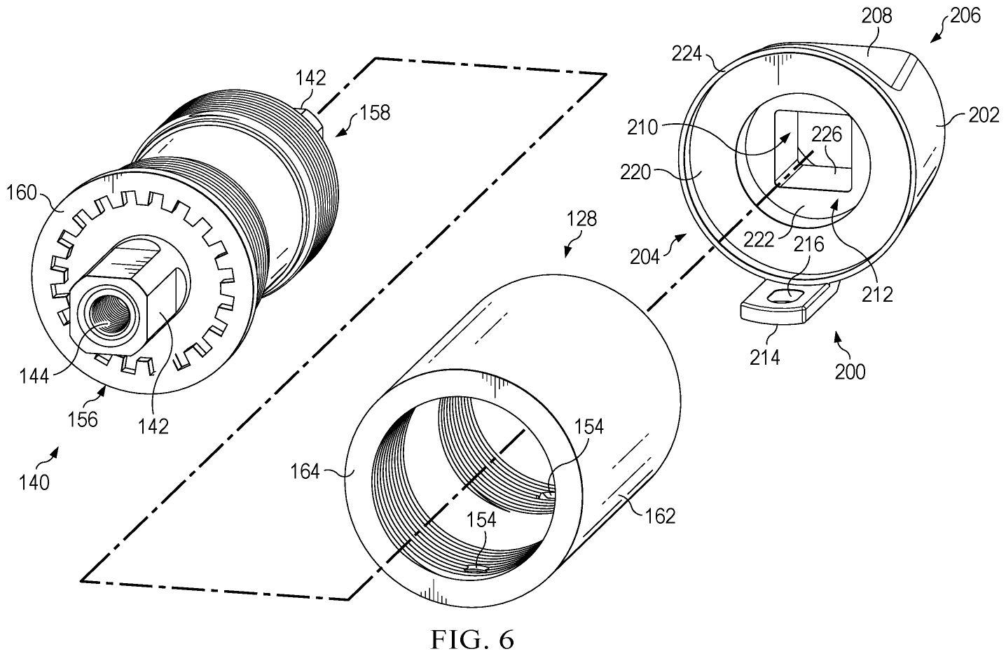

An annular surface of the inner side of each cover 200 contacts an outer face of the bottom bracket shell 128, as described further with reference to FIG. 6, below. The covers may be described as substantially covering a first end 156 of the bottom bracket and a second, opposing end 158 of the bottom bracket. Spindle 142 is received in a cover at each of ends 156, 158.

In the depicted example, each cover 200 includes a circular distal recess 220 at the inner side. A second, circular proximal recess 222 of a smaller diameter is concentrically inset into the distal recess. Both the distal and proximal recesses 222 may be described as in communication with central aperture 212 of body 202, or as forming a section of the central aperture. Distal recess 220 is configured to receive a flange 160 of bottom bracket 140, while proximal recess 222 is configured to accommodate a flared portion of spindle 142.

In general, cover 200 may include any recesses, openings, chambers, or spaces appropriate to receive structures of a bottom bracket. Some features of a bottom bracket may be asymmetrical. That is, structures present at the first end of the bottom bracket may be absent at the second end, and vice versa. For example, first end 156 of bottom bracket 140 includes flange 160, while second end 158 does not. In some examples, covers 200 may be configured for use on either end of the bottom bracket, and may include sufficient internal space to receive all structures of the bottom bracket, as in the present example. In some examples, covers 200 may not be identical and may be shaped to conform to a specific end of the bottom bracket.

FIG. 6 is an exploded view of bottom bracket 140, bottom bracket shell 128, and cover 200. As shown, each is at least roughly cylindrical in shape. Bottom bracket shell 128 is substantially cylindrical, with an outer circumferential surface 162 and two outer end surfaces 164, only one of which is depicted in FIG. 6.

In the present example, cover 200 includes a flange or rim at an edge of inner side 204 of body 202, with a flat surface 224. Flat surface 224 has an outer diameter matching an outer diameter of outer end surface 164 of bottom bracket shell 128. When cover 200 is mounted to bottom bracket 140, flat surface 224 contacts outer end surface 164 and the matching diameters mean that cover 200 is flush with the bottom bracket shell. In other words there the is no protruding lip where the cover meets the bottom bracket shell, and the cover does not stand proud of the bottom bracket shell.

In some examples, cover 200 may include a contact surface of different shape or position, and/or may be configured to contact a different surface of the bottom bracket shell. For instance, the flange at the end of the inner side may have a greater diameter than outer end surface 164, and an inner circumferential surface of the flange may be configured to contact outer circumferential surface 162 of the bottom bracket shell.

Central aperture 212 of body 202 of cover 200 extends from inner side 204 through the body to outer side 206. The central aperture may be described as varying in cross-sectional shape and size, and/or as being comprised of a plurality of sections of different cross-sectional shape and size. In the present example, central aperture 212 includes circular distal recess 220, circular proximal recess 222, a square passage 226, and recess 210. Square passage 226 is shaped to correspond to the four flat sides and rounded corners of spindle 142, and may include a matching taper or may be sized to accommodate the largest dimension of the tapered spindle.

The cross-sectional shapes and extent of each section of central aperture 212 may depend on the geometry of the bottom bracket or brackets which cover 200 is configured to accommodate.

FIG. 7 is an exploded view of rear dropout assembly 300, including a first portion 302 fixed to a seat stay 122, and a second portion 304 fixed to a chain stay 126. Second portion 304 includes one rear dropout 116 of the bicycle's two rear dropouts. Assembly 300 may be on the same side of the bicycle as the chain and chainring. The other rear dropout 116, seat stay 122, and chain stay 126 may be fixedly connected, according to any appropriate frame manufacturing methods.

Assembly 300 is configured for disconnection to allow removal of the bicycle's chain. In the depicted example, first portion 302 is fastened to second portion 304 by a hex bolt 306. Assembly 300 may therefore be disconnected and reconnected using only a hex wrench. Seat stay 122 and/or chain stay 126 may have sufficient flexibility to allow the disconnected portions to be moved apart enough to allow the chain to pass between the two portions.

In some examples, the first and second portions may be fastened by two or more fasteners and/or by other fasteners configured for use with common tools. In some examples, assembly 300 may include a third portion to which each of the first and second portions are fastened. In such examples, the third portion may be fully removable from the frame of the bicycle.

Each of portions 302 and 304 includes a recessed contact face 308. First portion 302 includes a threaded hole 310 to engage bolt 306, and second portion 304 includes a hole 312 in a circular recess 314 to receive and retain the head of the bolt. When connected, face 308 of first portion contacts face 308 of second portion 304. The receipt of each portion in the recess of the other portion may provide improved force transfer between the first and second portions, allowing assembly 300 to act as a single structural member.

In general, assembly 300 may have any structure or geometry appropriate to the design of the bicycle. The assembly may be configured to provide equivalent strength and performance as a fixed frame element. Assembly 300 may comprise the same material as seat stay 122 and chain stay 126 and/or any sufficiently strong and light material or materials.

### B. Illustrative Bottom Bracket Cover

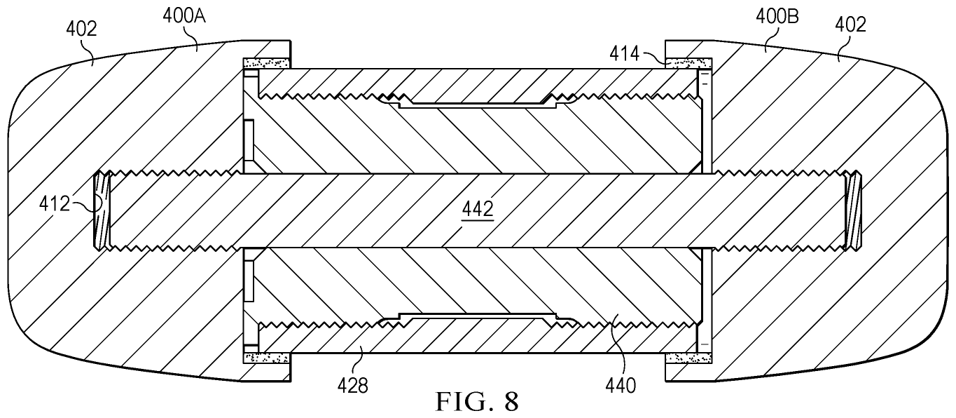

As shown in FIG. 8, this section describes an illustrative pair of covers 400. Each cover 400 is another example of a bottom bracket cover, as described above.

Covers 400 are depicted installed on a bottom bracket 440 and bottom bracket shell 428 of a bicycle. The bicycle may be a standard bicycle or a convertible bicycle, converted to a balance bicycle or balance bicycle configuration. A 2-piece crankset including a crank arm with integral spindle or crank axle may have been removed from the bicycle, leaving bottom bracket 440 with a central passage extending from a first end to a second of the bracket.

In the present example, covers 400 are identical and may be reversible. That is, each cover may be mounted to either end of bottom bracket 440. Each cover 400 includes a threaded central aperture 412, extending from an inner side of the cover. Central aperture 412 extends partway through a body 402 of the cover, but does not reach an outer side of the cover.

Each cover is attached to an elongate member, axle, or spindle 442. Spindle 442 extends through the central passage of bottom bracket 440 to be received in central aperture 412 of each cover 400, engaging the covers with the bottom bracket. Spindle 442 may closely correspond to the integral crank axle of a removed crank arm. Each distal end of spindle 442 is threaded to engage one of covers 400.

Each of covers 400 includes a lip or flange at the inner side, which overlaps bottom bracket shell 428. An underside or inner circumferential side of the flange has a coating 414 of a compressible, high friction material such as silicone rubber. Coating 414 may frictionally engage bottom bracket shell 428, to resist rotation of covers 400.

A user installing covers 400 may first insert spindle 442 through bottom bracket 440, then screw covers 400 onto the ends of the spindle. As the covers are drawn together by the threaded engagement, and the flange on each cover is drawn over bottom bracket shell 428, coating 414 may begin to resist rotation of the covers. The user's manual rotation of the covers may be sufficient to overcome the resistance of coating 414, allowing covers 400 to be tightened onto spindle 442.

In use, coating 414 may provide sufficient resistance to prevent unwanted rotation of covers 400 and maintain the covers in a fixed orientation. Any rotation that does occur may be of the first and second covers together, avoiding loosening of the threaded engagement. Covers 400 are also radially symmetrical, such that any rotation may not pose an inconvenience or danger to a rider of the bicycle.

In some examples, covers 400 may be configured to allow rotation. In some examples, spindle 442 may be an integral structure of a first one of the covers, threadedly engaged with the other cover. Any effective means of engaging covers 400 with bottom bracket 440 may additionally or alternatively be included.

### C. Illustrative Method of Converting a Convertible Bicycle

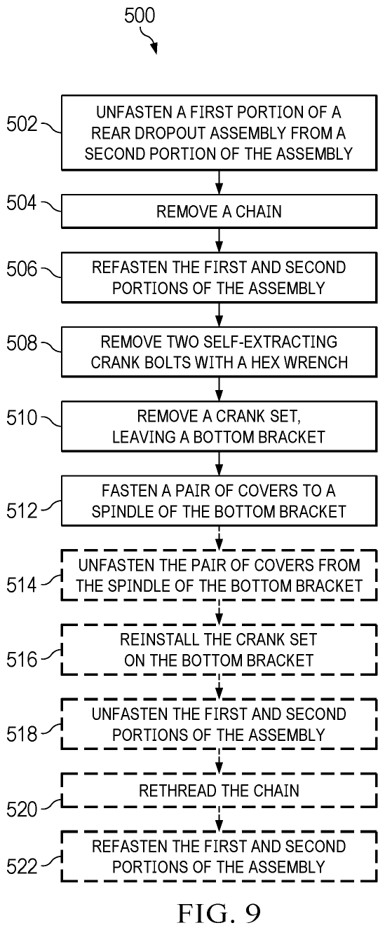

This section describes steps of an illustrative method 500 for converting a convertible bicycle; see FIG. 9. Aspects of bicycles and/or bottom bracket covers described above may be utilized in the method steps described below. Where appropriate, reference may be made to components and systems that may be used in carrying out each step. These references are for illustration, and are not intended to limit the possible ways of carrying out any particular step of the method.

FIG. 9 is a flowchart illustrating steps performed in an illustrative method, and may not recite the complete process or all steps of the method. Although various steps of method 500 are described below and depicted in FIG. 9, the steps need not necessarily all be performed, and in some cases may be performed simultaneously or in a different order than the order shown.

Method 500 may be described as converting a convertible bicycle from a pedal bike or pedal configuration to a balance bike or balance configuration. Optionally, the method may further include converting the bicycle back to the pedal configuration.

At step 502, method 500 includes unfastening a first portion of a rear dropout assembly of the bicycle from a second portion of the assembly. The first portion may be fixed to a seat stay, and the second portion fixed to a chain stay. Either the first portion or the second portion may include a rear dropout to engage a rear axle of the bicycle. The first and second portion may be fastened together by one or more bolts, screws, nuts, cotter pins, and/or other fastener assemblies. Unfastening the first portion from the second portion may include using a common tool to remove the fastener assemblies. For example, step 502 may include using a hex wrench of a first size to unthread a hex bolt.

Step 504 includes removing a chain of the bicycle. The chain may be slid between the unfastened first and second portions of the rear dropout assembly. Sufficiently clearance between the first and second portions may be achieved when unfastened, to allow the chain to pass between the two portions without opening any link of the chain. That is, the chain may be removed from the bicycle without any alteration to the chain. No chain tool, master link pliers, or other specialized equipment may be needed to perform step 504.

At step 506, the method include refastening the first and second portions of the rear dropout assembly. The step may include reversing step 502. For example, step 506 may include inserting a hex bolt into corresponding apertures of the first and second portions and using a hex wrench to engage the threads of the bolt and tighten the two portions together.

Steps 502-506 may be performed prior to steps 508-512 of method 500, subsequent to steps 508-512, and/or in parallel with some or all of steps 508-512.

Step 508 includes removing two self-extracting crank bolts, and step 510 includes removing a crankset, leaving a bottom bracket in a bottom bracket shell of the bicycle. As discussed above, a self-extracting crank bolt may be configured to disconnect a crank arm from a bottom bracket as the bolt is removed from the bottom bracket. Accordingly, aspects of steps 508 and 510 may be performed concurrently.

Removing each self-extracting crank bolt may include using a hex wrench of a second size to unthread the bolt from the bottom bracket. Interaction between the cap or cover of the bolt and the head of the bolt may disengage the crank arm from the bottom bracket as the bolt is unthreaded. The bolt, cap, and crank arm may then be removed from the bottom bracket together. Subsequently, a hex wrench of a third size may be used to unthread the cap of the self-extracting crank bolt from the crank arm, and remove the cap and bolt from the crank arm for use in step 512.

Removing the crankset from the bicycle may include removing two crank arms, along with attached pedals and one or more chainrings. The crankset may be stored for later use in optional step 516. As step 510 includes leaving the bottom bracket, no bottom bracket tool may be required.

Step 512 of method 500 includes fastening a pair of covers to a spindle of the bottom bracket and to the frame. In some examples, the bottom bracket may be a square taper bracket, and the bottom bracket shell may be a standard cylindrical or frame lug style bottom bracket shell. Each cover of the pair may be an example of a bottom bracket cover as described above, including but not limited to covers 200 or 400, as described in examples A and B.

In some examples, each cover may be fastened to the spindle of the bottom bracket using one of the two self-extracting crank bolts removed at step 508. The self-extracting crank bolts may be installed with or without the threaded cap. When the covers are installed in the balance configuration, each bolt may engage the spindle equivalently to when the crankset is installed in the pedal configuration. That is, each bolt may be threaded into a central aperture of the spindle, trapping a portion of the cover between the head of the bolt and the spindle.

In some examples, each cover may be fastened to the spindle of the bottom bracket using another fastener. For instance, each covers may be provided with separate and/or integral fastener such as a bolt or a threaded portion. The fastener may be sized and/or otherwise configured to engage the spindle of the bottom bracket, for instance by threadedly engaging a central aperture of the spindle.

In some examples, each cover may include a tab, flange or other portion overlapping the bottom bracket shell or other portion of the frame. Fastening the cover to the frame may include inserting a fastener through a hole or slot of the overlapping portion to engage the frame. The fastener may be a hex bolt or any effective fastener, and may engage a corresponding threaded hole in the frame, or may frictionally engage a surface of the frame.

Steps 514-522 are depicted as optional, and may be performed to return the convertible bicycle from the balance configuration to the pedal configuration. At step 514, the method includes unfastening the pair of covers from the spindle of the bottom bracket and the frame. The same tools may be used as in step 512, to remove the installed fasteners. For example, a hex wrench may be used to remove the self-extracting crank bolt and a hex bolt in a tab of each cover.

Step 516 includes reinstalling the crankset on the bottom bracket. The removed self-extracting crank bolt may be used to refasten the crank arms to the bottom bracket, thereby reattaching the chainrings and pedals. The hex wrench of the second size may be used to fasten each bolt, and the hex wrench of the third size may be used to thread the cap over each bolt, into the respective crank arm.

Steps 518 and 522 may be performed in the same manner as steps 502 and 506, respectively. While the first and second portions of the assembly are unfastened, step 520 includes rethreading the chain onto the bicycle, by sliding the chain between the first and second portions of the assembly.

Steps 502-520 may be repeated as desired, to convert the bicycle between pedal and balance configurations. Such repeated conversion may be useful for multiple learners to utilize the same bicycle. For example, a child sized convertible bike may be used by multiple siblings when learning to ride a bike.

### D. Illustrative Method of Converting a Standard Bicycle

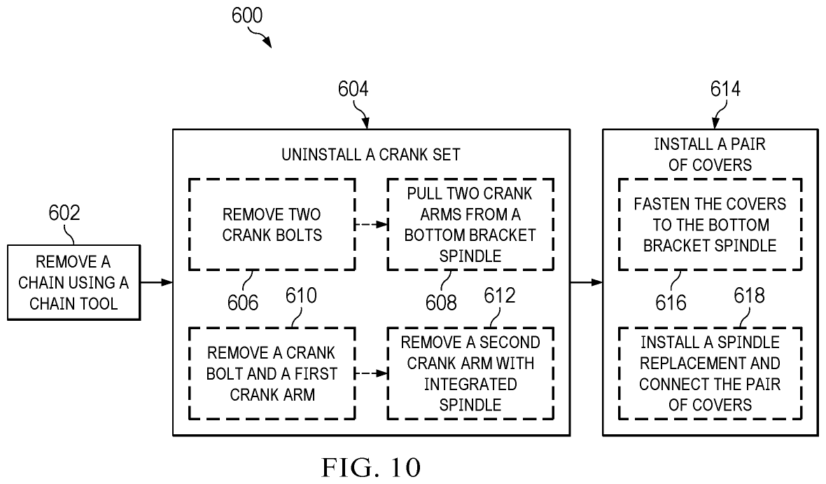

This section describes steps of an illustrative method 600 for converting a pedal bicycle to a balance bicycle; see FIG. 10. Aspects of bicycles and/or bottom bracket covers described above may be utilized in the method steps described below. Where appropriate, reference may be made to components and systems that may be used in carrying out each step. These references are for illustration, and are not intended to limit the possible ways of carrying out any particular step of the method.

FIG. 10 is a flowchart illustrating steps performed in an illustrative method, and may not recite the complete process or all steps of the method. Although various steps of method 600 are described below and depicted in FIG. 10, the steps need not necessarily all be performed, and in some cases may be performed simultaneously or in a different order than the order shown.

Method 600 may be performed on any bicycle that an owner or rider may desire to convert to a balance bicycle. Optional sub-steps 606-612 and 616-618 may be selected according to the components of the bicycle being converted. In some examples, primary step 604 or 614 may be performed in manner different from the described sub-steps, for a bicycle having different components.

At step 602, the method includes removing a chain from the bicycle using a chain tool. The step may be performed according to normal maintenance procedure for the chain and/or bicycle, using the tool appropriate to that chain.

Step 604 of the method includes uninstalling a crankset. The step may be performed according to normal maintenance procedure for the crankset, bottom bracket, and/or bicycle, using the crank puller or other tool appropriate to that crankset.

For example, optional sub-steps 606 and 608 include removing two crank bolts and pulling two crank arms from a bottom bracket spindle. Steps 606-608 may be appropriate to a 3-piece crankset. For another example, optional sub-step 610 includes removing a crank bolt and a first crank arm. Optional sub-step 612 includes removing a second crank arm along with an integrated spindle. Steps 610-612 may be appropriate to a 2-piece crankset.

Step 614 of the method includes installing a pair of covers. Each cover of the pair may be an example of a bottom bracket cover as described above, including but not limited to covers 200 or 400, as described in examples A and B. The covers may be mounted to a bottom bracket of the bicycle, according to the type of bottom bracket.

For example, optional sub-step 616 includes fastening covers to the bottom bracket spindle. Each cover may be fastened with one of the crank bolts removed at step 606, by inserting the crank bolt through a central aperture of a body of the cover to engage the spindle of the bottom bracket.

For another example, optional sub-step 618 includes installing a spindle replacement and connecting the pair of covers to the spindle replacement. The spindle replacement may be inserted through a passage of the bottom bracket, previously occupied by the integrated spindle removed at step 612. The covers may then be engaged with the bottom bracket by fastening to or otherwise engaging the replacement spindle. In some examples, the replacement spindle may be integrated with and/or fastened to one of the covers prior to insertion through the bottom bracket. In some examples, installing the pair of covers may further include engaging one or more elements of one or both of the covers with a bottom bracket shell or other portion of a frame of the bicycle. For instance, a fastener may be installed through a tab of the cover to frictionally engage a surface of the frame, or a high-friction coated portion of the cover may be tightened against the frame.

### Illustrative Combinations and Additional Examples

This section describes additional aspects and features of convertible bicycles, bottom bracket covers, and methods of converting a bicycle, presented without limitation as a series of paragraphs, some or all of which may be alphanumerically designated for clarity and efficiency. Each of these paragraphs can be combined with one or more other paragraphs, and/or with disclosure from elsewhere in this application, including materials incorporated by reference, in any suitable manner. Some of the paragraphs below expressly refer to and further limit other paragraphs, providing without limitation examples of some of the suitable combinations.

A0. A cover for a bottom bracket of a bicycle, comprising: a rounded body, including: an inner side having a surface configured to contact an outer surface of a bottom bracket shell of the bicycle; an outer side opposite the inner side; and a central aperture extending through the body from the inner side to the outer side; a first fastener, extending through the central aperture; and an engaging element configured to prevent rotation of the rounded body by engaging the bottom bracket shell of the bicycle.

A1. The cover of A0, wherein: the rounded body further includes a tab extending parallel the central aperture from an edge of the inner side, and having an aperture; and the engaging element includes a second fastener, extending through the aperture of the tab.

A2. The cover of A1, wherein the aperture of the tab is an elongate slot.

A3. The cover of A1 or A2, wherein the tab is disposed at a lower end of the body.

A4. The cover of any of A0-A3, wherein the central aperture is shaped to correspond to a spindle of the bottom bracket.

A5. The cover of A4, wherein the central aperture is tapered and has a rounded square cross-sectional shape.

A6. The cover of A4 or A5, wherein the first fastener is a crank bolt of the bicycle.

A7. The cover of A6, wherein the first fastener is a self-extracting crank bolt.

A8. The cover of any of A0-A7, wherein the first fastener engages a spindle of the bottom bracket.

A9. The cover of any of A0-A8, wherein the rounded body further includes a flat upper surface configured for use as a foot rest;

B0. A balance bicycle, comprising: a frame including a bottom bracket shell; a bottom bracket in the bottom bracket shell; and a first cover over a first end of the bottom bracket, and a second cover over a second end of the bottom bracket; wherein each cover is fastened to the bottom bracket.

B1. The balance bicycle of B0, wherein each cover includes: a central aperture extending through a body of the cover from an inner side to an outer side; and a first fastener, extending through the central aperture to engage the bottom bracket.

B2. The balance bicycle of B1, wherein the inner side of each cover includes a contact surface in contact with an outer surface of the frame, and each cover includes an engaging element engaged with the frame to prevent rotation of the cover.

B3. The balance bicycle of B2, wherein: each cover further includes a tab extending parallel the central aperture from an edge of the inner side, and having an aperture; and each engaging element includes a second fastener, extending through the aperture of the respective tab to engage the frame.

B4. The balance bicycle of any of B1-B2, wherein the first fastener of each cover engages a spindle of the bottom bracket.

B5. The balance bicycle of B4, wherein the central aperture of each cover receives the spindle of the bottom bracket.

B6. The balance bicycle of B5, wherein the first fastener of each cover is a crank bolt of the bicycle.

B7. The balance bicycle of any of B0-B6, wherein the covers are fastened to the bottom bracket by a spindle replacement member extending through the first cover, the bottom bracket, and the second cover.

B8. The balance bicycle of any of B0-B7, wherein each cover is fixedly mounted to the frame and the bottom bracket.

B9. The balance bicycle of any of B0-B8, wherein each cover substantially covers the respective end of the bottom bracket.

C0. A foot rest of a bicycle, comprising: a body having a flat upper surface, and a lower tab; a crank bolt extending through the body to engage a spindle of a bottom bracket of the bicycle; and a threaded fastener, extending through an aperture of the tab; wherein the foot rest covers one end of the bottom bracket and is mounted to the bicycle in a fixed orientation.

D0. A cover for a bottom bracket of a bicycle, comprising: a rounded body, including: an inner side having a flat contact surface; an outer side having a circular recess; a central aperture extending through the body from the inner side to the outer side; a flat upper surface configured for use as a foot rest; a tab extending parallel the central aperture from an edge of the inner side, and having an aperture; a first fastener, extending through the central aperture; and a second fastener, extending through the aperture of the tab.

E0. A balance bicycle, comprising: a frame; a bottom bracket in the frame; and a first foot rest mounted to a first end of the bottom bracket, and a second foot rest mounted to a second end of the bottom bracket, each foot rest including: a central aperture extending through the foot rest from an inner side to an outer side; a flat upper surface; a tab extending parallel the central aperture from an edge of the inner side, and having an aperture; a first fastener, extending through the central aperture to engage the bottom bracket; and a second fastener, extending through the aperture of the tab into the frame.

F0. A convertible bicycle, comprising: a frame including a bottom bracket shell and a disconnectable assembly, wherein the disconnectable assembly has a first portion fastened to a second portion; and a bottom bracket mounted in the bottom bracket shell; wherein the convertible bicycle has a pedal configuration in which the bicycle includes a crankset fastened to the bottom bracket, and a balance configuration in which the bicycle includes a pair of covers fastened to the bottom bracket.

F1. The bicycle of F0, wherein the disconnectable assembly includes a rear dropout.

F2. The bicycle of F0 or F1, wherein the first portion of the disconnectable assembly is fixed to a seat stay of the frame, and the second portion is fixed to a chain stay of the frame.

F3. The bicycle of any of F0-F2, wherein the first portion of the disconnectable assembly is fastened to the second portion by a hex bolt.

F4. The bicycle of any of F0-F3, wherein the crankset includes at least one chainring, and in the pedal configuration the bicycle includes a chain.

F5. The bicycle of any of F0-F4, wherein the bicycle includes pedals mounted to the crankset in the pedal configuration.

F6. The bicycle of any of F0-F5, wherein the crankset is fastened to the bottom bracket by at least one self-extracting crank bolt.

F7. The bicycle of F6, wherein the covers are fastened to the bottom bracket by the at least one self-extracting crank bolt.

G0. A method of converting a pedal bicycle to a balance bicycle, comprising: providing a convertible bicycle including a frame assembly having a first portion fastened to a second portion; unfastening the first portion from the second portion; removing a chain from the bicycle, including passing the chain between the first and second portions of the frame assembly; and refastening the first portion to the second portion.

H0. A method of converting a pedal bicycle to a balance bicycle, comprising: providing a convertible bicycle including at least one self-extracting crank bolt; removing a crankset from a bottom bracket of the convertible bicycle by unfastening the at least one self-extracting crank bolt; and fastening a cover over each of two ends of the bottom bracket.

J0. A method of converting a pedal bicycle to a balance bicycle, comprising: providing a convertible bicycle including a disconnectable frame assembly and at least one self-extracting crank bolt; disconnecting a first portion of the disconnectable frame assembly from a second portion of the disconnectable frame assembly by removing a fastener; removing a chain from the bicycle, including passing the chain between the disconnected first and second portions of the disconnectable frame assembly; reconnecting the first portion of the disconnectable frame assembly to the second portion of the disconnectable frame assembly, using the fastener removing a crankset from a bottom bracket of the convertible bicycle by unfastening the at least one self-extracting crank bolt; and fastening a cover to the bottom bracket.

K0. A method of converting a pedal bicycle to a balance bicycle, comprising: removing a chain from a bicycle; removing a crankset from the bicycle, including disconnecting crank arms of the crankset from a bottom bracket of the bicycle; and fastening a cover to each of two opposing ends of the bottom bracket.

K1. The method of K0, wherein disconnecting crank arms of the crankset from the bottom bracket includes removing one or more crank bolts, and fastening a cover to each of the two opposing ends of the bottom bracket includes fastening the covers with the removed crank bolts.

K2. The method of K1, wherein removing the crank bolts includes using a crank puller.

K3. The method of any of K0-K2, wherein fastening a cover to each of the two opposing ends of the bottom bracket includes fastening the covers to a spindle of the bottom bracket.

K4. The method of any of K0-K3, wherein removing a chain includes using a link opening tool.

### Advantages, Features, and Benefits

The different examples of the convertible bicycles, bottom bracket covers, and conversion methods described herein provide several advantages over known solutions for converting a bicycle between pedal and balance operation. For example, illustrative examples described herein allow conversion between pedal bike and balance bike configurations using only commonly available tools.

Additionally, and among other benefits, illustrative examples described herein allow conversion between pedal bike and balance bike configurations without compromising weight, strength, or performance in either configuration.

Additionally, and among other benefits, illustrative examples described herein allow conversion of a standard bicycle to a balance bike without removing the bicycle's bottom bracket.

No known system or device can perform these functions, particularly in a manner easily accessible to riders or owners new to bike maintenance. Thus, the illustrative examples described herein are particularly useful for guardians teaching a child to ride a bicycle. However, not all examples described herein provide the same advantages or the same degree of advantage.

### CONCLUSION

The disclosure set forth above may encompass multiple distinct examples with independent utility. Although each of these has been disclosed in its preferred form(s), the specific examples thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A cover for a bottom bracket of a bicycle, comprising:
a rounded body, including:
an inner side having a surface configured to contact an outer surface of a bottom bracket shell of the bicycle;
an outer side opposite the inner side; and
a central aperture extending through the body from the inner side to the outer side;
a first fastener, extending through the central aperture; and
an engaging element configured to prevent rotation of the rounded body by engaging the bottom bracket shell of the bicycle.

2. The cover of claim 1, wherein:
the rounded body further includes a tab extending parallel the central aperture from an edge of the inner side, and having an aperture; and
the engaging element includes a second fastener, extending through the aperture of the tab.

3. The cover of claim 2, wherein the aperture of the tab is an elongate slot.

4. The cover of claim 2, wherein the tab is disposed at a lower end of the body.

5. The cover of claim 1, wherein the central aperture is shaped to correspond to a spindle of the bottom bracket.

6. The cover of claim 5, wherein the central aperture is tapered and has a rounded square cross-sectional shape.

7. The cover of claim 5, wherein the first fastener is a crank bolt of the bicycle.

8. The cover of claim 7, wherein the first fastener is a self-extracting crank bolt.

9. The cover of claim 1, wherein the first fastener engages a spindle of the bottom bracket.

10. The cover of claim 1, wherein the rounded body further includes a flat upper surface configured for use as a foot rest.

11. A balance bicycle, comprising:
a frame including a bottom bracket shell;
a bottom bracket in the bottom bracket shell; and
a first cover over a first end of the bottom bracket, and a second cover over a second end of the bottom bracket;
wherein each cover is fastened to the bottom bracket.

12. The balance bicycle of claim 11, wherein each cover includes:
a central aperture extending through a body of the cover from an inner side to an outer side; and
a first fastener, extending through the central aperture to engage the bottom bracket.

13. The balance bicycle of claim 12, wherein the inner side of each cover includes a contact surface in contact with an outer surface of the frame, and each cover includes an engaging element engaged with the frame to prevent rotation of the cover.

14. The balance bicycle of claim 13, wherein:
each cover further includes a tab extending parallel the central aperture from an edge of the inner side, and having an aperture; and
each engaging element includes a second fastener, extending through the aperture of the respective tab to engage the frame.

15. The balance bicycle of claim 12, wherein the first fastener of each cover engages a spindle of the bottom bracket.

16. The balance bicycle of claim 15, wherein the central aperture of each cover receives the spindle of the bottom bracket.

17. The balance bicycle of claim 16, wherein the first fastener of each cover is a crank bolt of the bicycle.

18. The balance bicycle of claim 11, wherein each cover is fixedly mounted to the frame and the bottom bracket.

19. The balance bicycle of claim 11, wherein each cover substantially covers the respective end of the bottom bracket.

20. A foot rest of a balance bicycle, comprising:
a body having a flat upper surface, and a lower tab;
a crank bolt extending through the body to engage a spindle of a bottom bracket of the bicycle; and
a threaded fastener, extending through an aperture of the tab;
wherein the foot rest covers one end of the bottom bracket and is mounted to the bicycle in a fixed orientation.
